(19) United States
(12) Patent Application Publication
(10) Pub. No.: US 2018/0147527 A1
(43) Pub. Date: May 31, 2018

(54) CARBON DIOXIDE ABSORBENT MATERIAL, PELLET, AND FILTER

(71) Applicant: SHARP KABUSHIKI KAISHA, Sakai City, Osaka (JP)

(72) Inventors: HIDEHARU TAJIMA, Sakai City (JP); TAKAYUKI NAKA, Sakai City (JP); HIROHISA YAMADA, Sakai City (JP); KENTARO KISHIRA, Sakai City (JP)

(21) Appl. No.: 15/578,838

(22) PCT Filed: Jun. 24, 2016
(86) PCT No.: PCT/JP2016/068821

§ 371 Date: Dec. 1, 2017

(30) Foreign Application Priority Data
Jun. 26, 2015 (JP) 2015-129079
Jun. 26, 2015 (JP) 2015-129080

(51) Int. Cl. B01D 53/14; B01J 20/10; C01B 33/32; C01B 32/50

(52) U.S. Cl. CPC B01D 53/1475; B01J 20/10; C01P 2002/72; C01B 32/50; B01D 2257/504; C01B 33/32

(57) ABSTRACT

Even in the case where a gas contains water, a decrease in absorption efficiency of carbon dioxide contained in the gas is suppressed. A carbon dioxide absorbent material (10) absorbs carbon dioxide contained in a gas and contains a tetravalent lithium silicate that exhibits water solubility.

### TECHNICAL FIELD

The present invention relates to a carbon dioxide absorbent material and so forth that absorb carbon dioxide contained in a gas.

### BACKGROUND ART

As recently reported by Lawrence Berkeley National Laboratory in the United States, a carbon dioxide concentration of 2,500 ppm or more decreases the ability to think. When the carbon dioxide concentration in the air becomes a particular concentration or more, the human body is adversely affected and thus it is necessary to prevent an increase in the carbon dioxide concentration in the air. Furthermore, some analytical instruments need to remove carbon dioxide from air taken therein. Therefore, techniques for removing carbon dioxide contained in a gas have been hitherto developed. For example, PTL 1 to PTL 3 disclose such techniques.

PTL 1 discloses a technique that includes causing carbon dioxide in a gas flow to adsorb on zeolite, thereby removing the carbon dioxide. PTL 2 discloses a technique that includes bringing a combustion exhaust gas into contact with an aqueous amine solution, thereby removing carbon dioxide in the combustion exhaust gas. PTL 3 discloses a carbonic acid gas absorbent material containing, as a main component, a lithium silicate containing a particular amount of water.

### CITATION LIST

### Patent Literature

PTL 1: Japanese Unexamined Patent Application Publication No. 11-253736 (published on Sep. 21, 1999)

PTL 2: Japanese Unexamined Patent Application Publication No. 8-252430 (published on Oct. 1, 1996)

PTL 3: Japanese Unexamined Patent Application Publication No. 2003-126688 (published on May 7, 2003)

### SUMMARY OF INVENTION

### Technical Problem

However, zeolite disclosed in PTL 1 is hydrophilic. Therefore, in the case where zeolite separates carbon dioxide from a gas containing water and carbon dioxide and adsorbs the carbon dioxide, the zeolite preferentially adsorbs water, resulting in a problem of a significant decrease in the capability of separating and adsorbing carbon dioxide. In addition, the technique disclosed in PTL 1 has a problem in that a dehumidification mechanism is necessary so as to prevent zeolite from adsorbing water.

The aqueous amine solution disclosed in PTL 2 is an aqueous solution having a particular concentration or more. Therefore, in the case where carbon dioxide is separated from the gas and absorbed, unless the aqueous amine solution is constantly regenerated, the concentration of the aqueous amine solution decreases, resulting in a problem of a decrease in characteristics of absorbing carbon dioxide. That is, unless the aqueous amine solution is treated so as to maintain the particular concentration or more, the concentration of the aqueous amine solution decreases, resulting in a problem in that the aqueous amine solution cannot absorb carbon dioxide. In addition, the technique disclosed in PTL 2 has a problem in that an absorption regeneration mechanism is necessary for adjusting the concentration of the aqueous amine solution so as to enable carbon dioxide to be absorbed again.

The carbonic acid gas absorbent material disclosed in PTL 3 absorbs water together with carbon dioxide. As a result, the amount of water contained in the carbonic acid gas absorbent material changes. Accordingly, there is a problem in that the carbonic acid gas absorbent material cannot absorb carbon dioxide when the content of water exceeds the particular amount.

As described above, in the techniques disclosed in PTL 1 to PTL 3, it is difficult to continue to absorb carbon dioxide from the gas for a long time. That is, in the techniques disclosed in PTL 1 to PTL 3, it is difficult to suppress a decrease in absorption efficiency of carbon dioxide contained in a gas when the gas contains water.

The present invention has been made in order to solve the problems described above. An object of the present invention is to provide a carbon dioxide absorbent material capable of suppressing a decrease in absorption efficiency of carbon dioxide contained in a gas even when the gas contains water.

### Solution to Problem

To solve the problems described above, a carbon dioxide absorbent material according to an aspect of the present invention is a carbon dioxide absorbent material that absorbs carbon dioxide contained in a gas, the carbon dioxide absorbent material containing a tetravalent lithium silicate that exhibits water solubility.

### Advantageous Effects of Invention

An aspect of the present invention is advantageous in that even when a gas contains water, a decrease in absorption efficiency of carbon dioxide contained in the gas can be suppressed.

### BRIEF DESCRIPTION OF DRAWINGS

FIG. 1 is a view illustrating an example of a measurement mechanism that measures a concentration of carbon dioxide in a container, according to Embodiment 1 of the present invention.

FIG. 2 is a graph showing an example of measurement results of the carbon dioxide absorbent material according to Embodiment 1 of the present invention, the measurement results being obtained by an X-ray diffractometer.

FIG. 3 is a graph showing transmittances of aqueous solutions containing a powder X or a powder Y for light having a wavelength of 240 nm or more and 400 nm or less.

FIG. 4 is a graph showing an example of a change in a concentration of carbon dioxide in the container with time, the concentration being measured with the measurement mechanism.

FIG. 5 is a graph showing an example of a change in a concentration of carbon dioxide in the container with time at two different humidities, the concentration being measured with the measurement mechanism.

FIG. 6 Part (a) and part (b) are views illustrating an example of a filter according to Embodiment 2 of the present invention.

FIG. 7 is a view illustrating an example of a measurement mechanism that measures a concentration of carbon dioxide in a container, according to Embodiment 3 of the present invention.

FIG. 8 is a graph showing an example of a change in a concentration of carbon dioxide in the container with time, the concentration being measured with the measurement mechanism.

FIG. 9 is a graph showing another example of a change in a concentration of carbon dioxide in the container with time, the concentration being measured with the measurement mechanism.

FIG. 10 is a graph showing still another example of a change in a concentration of carbon dioxide in the container with time, the concentration being measured with the measurement mechanism.

FIG. 11 is a graph showing still another example of a change in a concentration of carbon dioxide in the container with time, the concentration being measured with the measurement mechanism.

FIG. 12 is a graph showing still another example of a change in a concentration of carbon dioxide in the container with time, the concentration being measured with the measurement mechanism.

FIG. 13 is a view illustrating another example of a measurement mechanism that measures a concentration of carbon dioxide in a container, according to Embodiment 3 of the present invention.

FIG. 14 is a graph showing an example of a change in a concentration of carbon dioxide in the container with time, the concentration being measured with the measurement mechanism illustrated in FIG. 13.

FIG. 15 is a graph showing an example of the relationship between an amount of potassium carbonate added to a tetravalent lithium silicate that exhibits water solubility and an amount of decrease in the concentration of carbon dioxide per predetermined time.

FIG. 16 Part (a) and part (b) are views illustrating an example of a filter according to Embodiment 4 of the present invention.

### DESCRIPTION OF EMBODIMENTS

### Embodiment 1

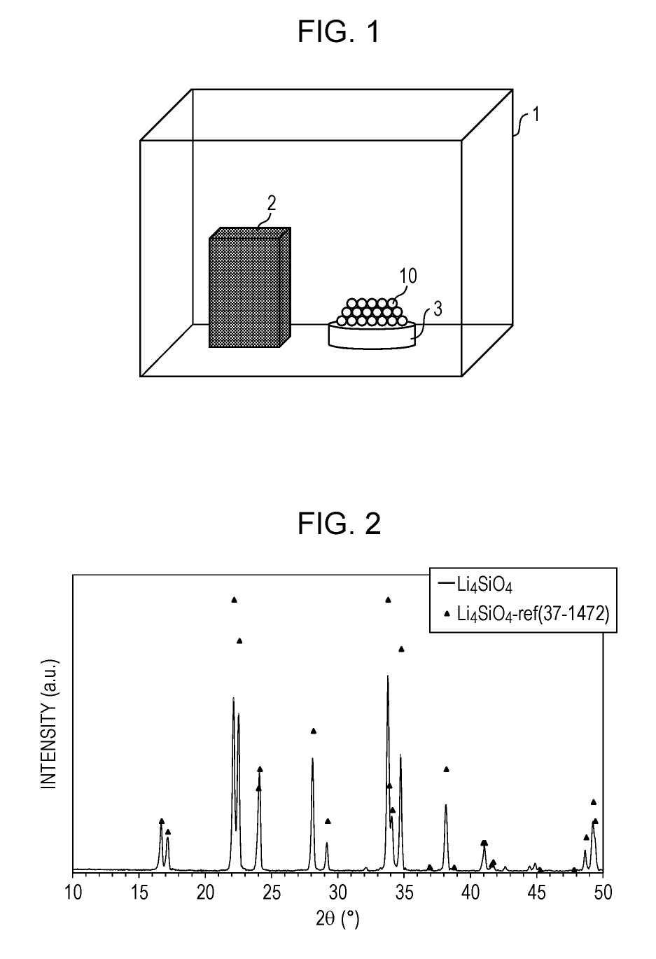

An embodiment of the present invention will now be described in detail with reference to FIGS. 1 to 5.

<Carbon Dioxide Absorbent Material 10>

FIG. 1 is a view illustrating an example of a measurement mechanism that measures a concentration of carbon dioxide in a container 1, according to the present embodiment. Specifically, the measurement mechanism illustrated in FIG. 1 measures an amount of carbon dioxide absorbed by a carbon dioxide absorbent material 10 or the like. Measurement results obtained by the measurement mechanism will be described below as Examples.

The carbon dioxide absorbent material 10 of the embodiment illustrated in FIG. 1 can absorb carbon dioxide contained in a gas. Specifically, the carbon dioxide absorbent material 10 can separate at least part of carbon dioxide from a gas containing water (that is, water vapor) and carbon dioxide (that is, carbonic acid gas) and absorb the carbon dioxide. The carbon dioxide absorbent material 10 contains a tetravalent lithium silicate (Li₄SiO₄) that exhibits water solubility.

The carbon dioxide absorbent material 10 of Examples, which will be described below, is mostly formed of a tetravalent lithium silicate that exhibits water solubility and contains the lithium silicate as a main component. In this embodiment, when a ratio of the tetravalent lithium silicate that exhibits water solubility to all the substances contained in the carbon dioxide absorbent material 10 is, for example, 80% or more, the lithium silicate is assumed to be a main component of the carbon dioxide absorbent material 10.

Herein, tetravalent lithium silicates are materials capable of separating carbon dioxide from the gas and absorbing the carbon dioxide and usually exhibit insolubility in water according to a published safety data sheet. That is, it is obvious from the safety data sheet that existing tetravalent lithium silicates including the tetravalent lithium silicate disclosed in PTL 3 exhibit insolubility in water. However, as a result of extensive studies, the inventors of the present invention found that a tetravalent lithium silicate that exhibits water solubility and that is capable of separating carbon dioxide from the gas and absorbing the carbon dioxide for a long time can be obtained by a production method described below. However, at present, the mechanism of the production of the tetravalent lithium silicate that exhibits water solubility is unclear in the production method described below.

### EXAMPLES

Next, a description will be given of a method for producing the carbon dioxide absorbent material 10 and absorption characteristics of the carbon dioxide absorbent material 10 produced by the production method.

(Method for Producing Carbon Dioxide Absorbent Material 10)

An example of a method for producing the carbon dioxide absorbent material 10 will be described.

First, silicon dioxide (SiO₂) and lithium carbonate (Li₂CO₃) are weighed so as to have a molar ratio of 1:2 (weighing step). Subsequently, the silicon dioxide and the lithium carbonate are charged in a three-dimensional mill. The silicon dioxide and the lithium carbonate are then mixed in the three-dimensional mill by using ZrO₂ balls for about 10 minutes (mixing step). The three-dimensional mill used in this production method is a 3D-210-D2 ball mill available from Nagao System Inc.

The silicon dioxide and lithium carbonate mixed in the three-dimensional mill (mixed powder) is heated in an electric furnace at a temperature of about 700° C. for 10 hours (heating step). The mixed powder after heating is crushed with a mortar, and the powder after crushing is sieved (crushing step). A powdery (powder-like) tetravalent lithium silicate is produced in this manner. The tetravalent lithium silicate produced by the production method of this Example has a particle size of about 20 μm (D50: median diameter). The tetravalent lithium silicate produced as described above is referred to as “powder X”. A sieve having a different opening may be used. In this case, a tetravalent lithium silicate having a particle size of about 8 μm (D50: median diameter) (referred to as “powder Y”) can be obtained. The inventors of the present invention confirmed that the tetravalent lithium silicate produced as described above is soluble in water.

Note that the mixing time in the mixing step varies depending on the total weight of silicon dioxide and lithium carbonate weighed in the weighing step. The heating temperature and the heating time in the heating step vary depending on the electric furnace used. Considering the difference in the electric furnace used, the heating temperature may be, for example, 600° C. or higher and 1,000° C. or lower, and the heating time may be, for example, 5 hours or more and 40 hours.

(Identification)

FIG. 2 is a graph showing an example of measurement results of the carbon dioxide absorbent material 10 according to this embodiment, the measurement results being obtained by an X-ray diffractometer (XRD; X-ray diffraction). The inventors of the present invention examined whether or not a substance actually produced by the production method described above was a tetravalent lithium silicate by identifying the substance with an X-ray diffractometer. In FIG. 2, the horizontal axis represents a diffraction angle, and the vertical axis represents an X-ray intensity after scattering with the substance. The “Li₄SiO₄” (solid line) in FIG. 2 represents the measurement result when the measurement object is the above substance. The “Li₄SiO₄-ref(37-1472)” (triangle mark) in FIG. 2 represents the analysis result of Li₄SiO₄ (Li₄SiO₄ which is a known substance and exhibits insolubility in water) used as a reference.

As shown in FIG. 2, the results show that the substance (solid line) has peaks at substantially the same diffraction angles as Li₄SiO₄ used as the reference. Specifically, the pattern of appearance of the peaks of the substance is substantially the same as the pattern of appearance of peaks of Li₄SiO₄ used as the reference. In addition, peaks showing, for example, characteristics of a divalent lithium silicate do not appear in FIG. 2. Accordingly, the above substance can be identified as a tetravalent lithium silicate. That is, the carbon dioxide absorbent material 10 produced by the production method described above can be determined as a substance containing a tetravalent lithium silicate as a main component.

(Examination of Water Solubility)

The inventors of the present invention have confirmed that, unlike existing tetravalent lithium silicates that exhibit insolubility in water, the above substance is a tetravalent lithium silicate that exhibits water solubility. This examination was performed by dropping the substance in water at room temperature. Here, 0.01 g of a tetravalent lithium silicate (for example, powder X) and 6 g of distilled water (having a pH of 6.0 or more and 8.0 or less) at room temperature are placed in a transparent glass container and stirred with a stirring bar and a stirrer for 5 minutes or more to prepare an aqueous solution containing the tetravalent lithium silicate in an amount of 0.17% by weight (≈0.01/6.01×100). When the aqueous solution after stirring is transparent as a result of visual observation, the produced tetravalent lithium silicate can be determined to exhibit water solubility.

Alternatively, when the aqueous solution has a transmittance of 88% or more for light having a wavelength of 240 nm or more and 400 nm or less, the produced tetravalent lithium silicate may be determined to exhibit water solubility. In other words, in the case where an aqueous solution containing 0.17% by weight of a tetravalent lithium silicate is prepared and the aqueous solution has a transmittance of 88% or more for light applied to the aqueous solution, the light having a wavelength in the above range, the produced tetravalent lithium silicate may be determined to exhibit water solubility.

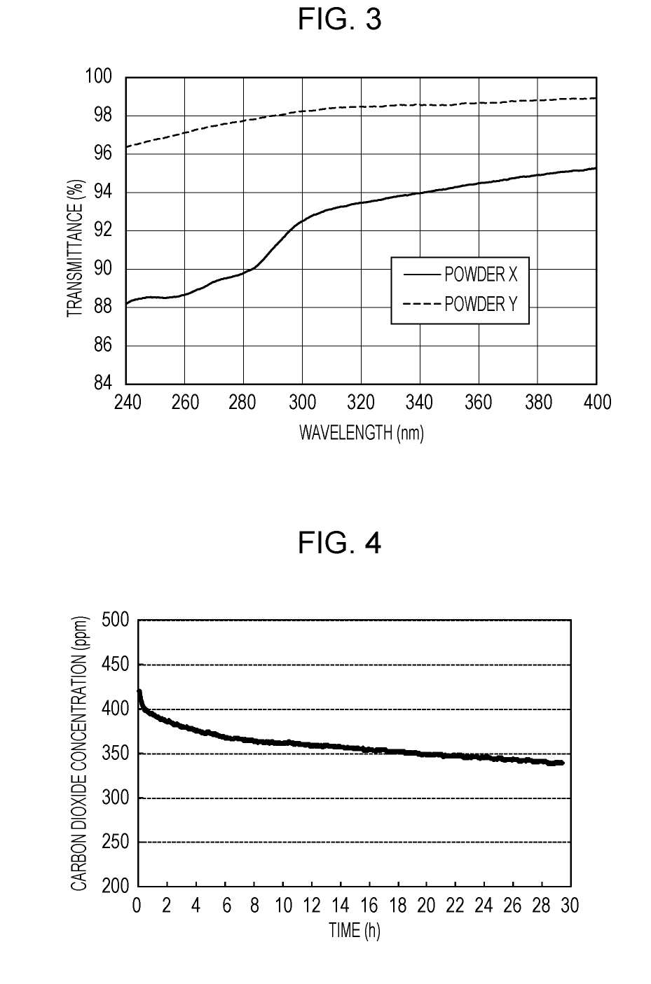

The transmittance is a value obtained when the above aqueous solution is placed in a quartz cell and a transmittance of the aqueous solution is measured by using a spectrophotometer (for example, V-550 available from JASCO Corporation) where a transmittance of the distilled water placed in a quartz cell is assumed to be 100%. FIG. 3 shows transmittances of an aqueous solution containing a powder X and an aqueous solution containing a powder Y for light having a wavelength in the above range. As shown in FIG. 3, the aqueous solution containing the powder X and the aqueous solution containing the powder Y each have a transmittances of 88% or more.

Furthermore, it is possible to examine whether the produced tetravalent lithium silicate exhibits water solubility by using methods described below besides the examination methods described above.

For example, 20 g of distilled water (having a pH of 6.0 or more and 8.0 or less) at room temperature is placed in a hermetic container, and 1 g of a tetravalent lithium silicate (for example, powder X) is added thereto. The resulting mixture is vigorously stirred for about 5 minutes by using a stirring bar and a stirrer so as not to generate a precipitate. Subsequently, the resulting solution is subjected to suction filtration by using filter paper (for example, glass fiber filter paper GF/B available from GE Healthcare Japan Corporation), and 15 g of the resulting filtrate is placed in a porcelain evaporating dish and immersed in a water bath at 70° C. or higher for about 30 minutes. Subsequently, the porcelain evaporating dish is maintained at 110° C. for 2 hours to evaporate water. When an increase in the weight of the porcelain evaporating dish per 100 g of the filtrate after the evaporation of water is 3.6 g or more, the produced tetravalent lithium silicate can be determined to exhibit water solubility. In other words, in the following case, the tetravalent lithium silicate contained in the carbon dioxide absorbent material 10 can be determined to exhibit water solubility. Specifically, after an aqueous solution prepared by dissolving the lithium silicate in distilled water in a ratio of 1 g of the lithium silicate relative to 20 g of the distilled water is filtered, and 100 g of the resulting filtrate is maintained at 110° C. for 2 hours, an evaporation residue having a weight of 3.6 g or more is yielded.

Alternatively, after the filtrate is maintained at 110° C. for 2 hours to evaporate water in the above process, the porcelain evaporating dish is maintained, for example, in an electric furnace at 700° C. for 10 hours. Also in the case where an increase in the weight of the porcelain evaporating dish per 100 g of the filtrate after the maintenance is 2.9 g or more, the produced tetravalent lithium silicate may be determined to exhibit water solubility. In other words, also in the following case, the tetravalent lithium silicate contained in the carbon dioxide absorbent material 10 can be determined to exhibit water solubility. Specifically, after an aqueous solution prepared by dissolving the lithium silicate in distilled water in a ratio of 1 g of the lithium silicate relative to 20 g of the distilled water is filtered, and 100 g of the resulting filtrate is maintained at 110° C. for 2 hours and further maintained at 700° C. for 10 hours, an evaporation residue having a weight of 2.9 g or more is yielded.

Here, water in the porcelain evaporating dish can be sufficiently evaporated by maintaining at 110° C. for 2 hours as described above. However, the possibility that water remains in the porcelain evaporating dish cannot be denied, though the possibility is very low. In addition, there is also a possibility that the tetravalent lithium silicate absorbs carbon dioxide during the maintenance for 2 hours. Therefore, the weight (3.6 g or more) of the evaporation residue yielded after the maintenance for 2 hours may include the weight of water that has not been completely evaporated and the weight of carbon dioxide absorbed by the lithium silicate besides the weight of the tetravalent lithium silicate. As described above, the porcelain evaporating dish after being maintained at 110° C. for 2 hours is further maintained at 700° C. for 10 hours, thereby removing almost all the water that has not been evaporated even after the maintenance for 2 hours and carbon dioxide that has been absorbed by the tetravalent lithium silicate during the maintenance for 2 hours. Accordingly, in the case where the temperature is further maintained at 700° C. for 10 hours, almost all the evaporation residue can be formed of a tetravalent lithium silicate, and thus the weight of the lithium silicate can be measured with a higher accuracy.

An example of the reason for the difference between water solubility and insolubility in water is believed to be the difference between the crystallinity of the tetravalent lithium silicate of this embodiment and the crystallinity of the existing tetravalent lithium silicates. However, the reason for the difference (the reason (mechanism) why the tetravalent lithium silicate of this embodiment exhibits water solubility) has not yet been made clear at the time of filing of the basic application of the present application.

In the case where the produced tetravalent lithium silicate is massive, for example, in the form of pellets, the tetravalent lithium silicate is crushed with a mortar, a ball mill, or the like to form a powder, and water solubility thereof can be examined in the powdered state. In the case where the carbon dioxide absorbent material 10 contains a substance other than the tetravalent lithium silicate, if possible, the tetravalent lithium silicate alone is isolated by using a known technique, and water solubility thereof is then examined. These also apply to a carbon dioxide absorbent material 10a of Embodiment 3.

(Absorption Characteristics of Carbon Dioxide Absorbent Material 10)

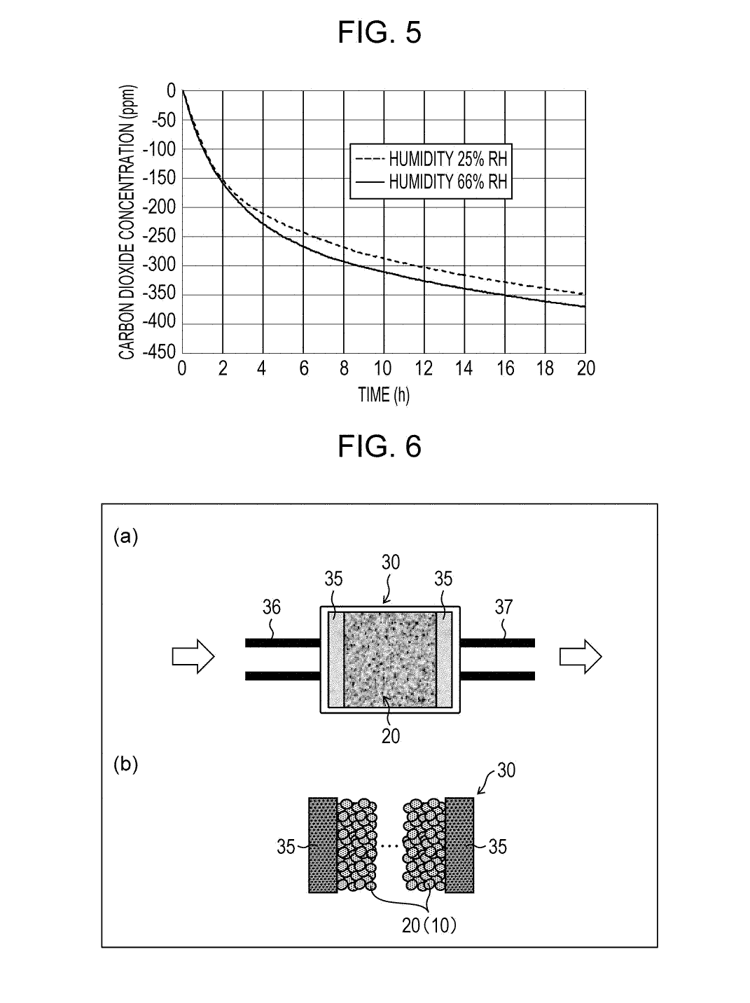

Next, examination results of absorption characteristics of the carbon dioxide absorbent material 10 produced by the production method described above will be described with reference to FIGS. 1, 4, and 5. FIG. 4 is a graph showing an example of a change in the concentration of carbon dioxide in the container 1 with time, the concentration being measured with the measurement mechanism illustrated in FIG. 1. FIG. 5 is a graph showing an example of a change in the concentration of carbon dioxide in the container 1 with time at two different humidities, the concentration being measured with the measurement mechanism illustrated in FIG. 1.

The measurement mechanism illustrated in FIG. 1 measures an amount of carbon dioxide absorbed by a carbon dioxide absorbent material such as the carbon dioxide absorbent material 10 produced by the production method described above and includes a container 1, a concentration measurement device 2, and a dish 3. This measurement mechanism actually measures a concentration of carbon dioxide in a gas contained in the container 1, to thereby measure the amount of carbon dioxide absorbed by the carbon dioxide absorbent material.

The container 1 is filled with a gas containing water and carbon dioxide and capable of making a measurement environment therein. The container 1 is provided with a cover (not shown) on an upper portion thereof. In this Example, the material of the container 1 is an acrylic resin. However, the material is not particularly limited as long as the container 1 can provide the above measurement environment. The concentration measurement device 2 measures the concentration of carbon dioxide in a gas contained in the container 1 in a state hermetically sealed by closing the cover and is installed in the container 1. The dish 3 is used for placing a carbon dioxide absorbent material therein and placed in the container 1.

A measurement method of this Example is as follows. First, the acrylic container 1 having an internal volume of 12 L was placed in air at a temperature of 23° C. and a humidity of 55% RH (relative humidity), so that the interior of the container 1 had an atmosphere that was the same as the air. Subsequently, 0.1 g of the carbon dioxide absorbent material 10 produced by the above production method and containing, as a main component, a tetravalent lithium silicate that exhibited water solubility was placed on the dish 3. The dish 3 was placed in the container 1. Subsequently, the cover of the container 1 was closed to hermetically seal the interior of the container 1. In this state, the concentration of carbon dioxide contained in the container 1 was measured with the concentration measurement device 2 with time. FIG. 4 shows the measurement results.

As shown in FIG. 4, after the start of the measurement, for a while (in this Example, for about several tens of minutes from the start of the measurement, as shown in FIG. 4), the concentration of carbon dioxide contained in the container 1 rapidly decreases compared with the subsequent period. This is presumably due to absorption of carbon dioxide by the carbon dioxide absorbent material 10 and physical adsorption of carbon dioxide on the surface of the carbon dioxide absorbent material 10.

Thereafter, the amount of decrease in the concentration of carbon dioxide per unit time becomes smaller than the amount of decrease per unit time during the above period after the start of the measurement. However, the concentration of carbon dioxide continues to decrease. Considering that the concentration of carbon dioxide contained in the container 1 also decreases with time, it is considered that the concentration of carbon dioxide continues to decrease at a substantially constant rate. That is, a carbon dioxide absorption rate of the carbon dioxide absorbent material 10 (the slope of the graph shown in FIG. 4) is considered to be substantially constant after the above period elapses from the start of the measurement. As shown in FIG. 4, the concentration of carbon dioxide in the container 1 continues to decrease over a period of about 30 hours from the start of the measurement.

In another measurement method, the container 1 was placed in air at a temperature of 23° C. or higher and 24° C. or lower and at a humidity of 25% RH or 66% RH, so that the interior of the container 1 had an atmosphere that was the same as the air. Subsequently, 0.5 g of the carbon dioxide absorbent material 10 was placed on the dish 3, and the dish 3 was placed in the container 1. Subsequently, the cover of the container 1 was closed to hermetically seal the interior of the container 1. In each of the state at a humidity of 25% RH and the state at a humidity of 66% RH, the concentration of carbon dioxide contained in the container 1 was measured with the concentration measurement device 2 with time.

FIG. 5 shows the measurement results. The concentration of carbon dioxide in each elapsed time shown in FIG. 5 is a value determined by subtracting the carbon dioxide concentration indicated by the concentration measurement device 2 at an elapsed time of zero (that is, at the start of the measurement) from the carbon dioxide concentration indicated by the concentration measurement device 2 at each elapsed time. In FIG. 5, the results are shown such that the concentration of carbon dioxide indicated by the concentration measurement device 2 at an elapsed time of zero becomes 0 ppm.

As shown in FIG. 5, the amount of decrease in the carbon dioxide concentration at a humidity of 66% RH is larger than that at a humidity of 25% RH. That is, it is found that the carbon dioxide absorption rate in the case where the carbon dioxide absorbent material 10 is placed in an environment at a high humidity of 66% RH is higher than that in the case where the carbon dioxide absorbent material 10 is placed in an environment at a low humidity of 25% RH.

<Absorption Principle>

As described above, carbon dioxide in the gas can be absorbed for a long time by using the carbon dioxide absorbent material 10 containing the tetravalent lithium silicate that exhibits water solubility. However, the absorption principle (mechanism of absorption) of carbon dioxide in the gas by the tetravalent lithium silicate that exhibits water solubility has not yet been made clear at the time of filing of the basic application of the present application. The inventors of the present invention believe that an example of the absorption principle is as follows.

Specifically, water contained in the gas adheres to a surface of the tetravalent lithium silicate contained in the carbon dioxide absorbent material 10, and the surface thereby becomes in a substantially molten state. Presumably, permeation of carbon dioxide inside the carbon dioxide absorbent material 10 is consequently facilitated, and carbon dioxide in the gas is thereby absorbed.

It is also presumable that a reaction proceeds on the surface while water functions as a catalyst, and carbon dioxide in the gas is thereby absorbed.

### Main Advantages of this Embodiment

The carbon dioxide absorbent material 10 of this embodiment contains a tetravalent lithium silicate that exhibits water solubility.

Here, since an existing carbon dioxide absorbent material (for example, the material disclosed in PTL 1 or 3) adsorbs or absorbs water contained in the gas, adsorption or absorption of carbon dioxide is inhibited accordingly. Therefore, the inhibition of absorption or adsorption of carbon dioxide due to water decreases the amount of adsorption or absorption of carbon dioxide contained in the gas per unit area of the carbon dioxide absorbent material. Accordingly, it is difficult for the existing carbon dioxide absorbent material to adsorb or absorb carbon dioxide for a long time when water is present in a gas. That is, in the case of the existing carbon dioxide absorbent material, it is difficult to maintain absorption of carbon dioxide when a gas contains water.

In contrast, in the carbon dioxide absorbent material 10 of this embodiment, presumably, water in a gas adheres to a surface of the tetravalent lithium silicate, and carbon dioxide is absorbed while the surface is melted, as described above. That is, water in a gas presumably contributes to the carbon dioxide absorption by the tetravalent lithium silicate. Therefore, the carbon dioxide absorbent material 10 can continue to absorb carbon dioxide in an environment in which a gas contains water, regardless of the amount of water contained per unit volume of the gas. That is, even in the case where a gas contains water, the carbon dioxide absorbent material 10 can suppress a decrease in absorption efficiency of carbon dioxide contained in the gas. Rather, it is believed that, on the basis of the presumption described above, water contained in a gas is the very reason why the carbon dioxide absorbent material 10 can continue to absorb carbon dioxide. Furthermore, on the basis of the assumption, with an increase in the amount of water in the gas (that is, with an increase in the humidity), the carbon dioxide absorption capacity of the carbon dioxide absorbent material 10 improves. Thus, the absorption rate of carbon dioxide can be increased, and the carbon dioxide absorbent material 10 can continue to absorb a larger amount of carbon dioxide. This is also supported by the measurement results shown in FIG. 5. That is, the carbon dioxide absorbent material 10 effectively functions in an environment in which a gas contains water and can absorb carbon dioxide for a long time.

As described above, unlike the existing carbon dioxide absorbent material, the carbon dioxide absorbent material 10 can absorb carbon dioxide in the gas even in the case where the gas contains water. Therefore, when the carbon dioxide absorbent material 10 is used and carbon dioxide is separated from the gas (in particular, the separation is performed for a long time), it is not necessary to arrange a dehumidification mechanism. Accordingly, the cost for arranging the dehumidification mechanism and the cost for operating the dehumidification mechanism can be reduced. Furthermore, the installation site of the dehumidification mechanism is unnecessary. The carbon dioxide absorbent material 10, which can continue to absorb carbon dioxide without using a dehumidification mechanism even in an environment in which a gas contains water, has not been realized by the existing carbon dioxide absorbent material.

Furthermore, in the case where the carbon dioxide absorbent material 10 is used, it is not necessary to arrange an absorption regeneration mechanism, which is necessary, in particular, when carbon dioxide is separated from the gas for a long time. Therefore, the cost for arranging the absorption regeneration mechanism and the cost for operating the absorption regeneration mechanism can be reduced. Furthermore, the installation site of the absorption regeneration mechanism is unnecessary. Note that the absorption regeneration mechanism is a mechanism that changes characteristics of a material contained in a carbon dioxide absorbent material so that absorption of carbon dioxide can be performed again.

As described above, the carbon dioxide absorbent material 10 containing the tetravalent lithium silicate that exhibits water solubility significantly differs from an existing carbon dioxide absorbent material (in particular, a tetravalent lithium silicate that exhibits insolubility in water) in characteristics thereof. This difference in characteristics can provide the carbon dioxide absorbent material 10, which has not been realized in the past. Specifically, it is possible to provide the carbon dioxide absorbent material 10 that is capable of absorbing carbon dioxide in the gas for a long time at a low cost and that effectively functions in an environment in which a gas contains water. The carbon dioxide absorbent material 10 is capable of absorbing carbon dioxide in the gas until the concentration of carbon dioxide in the gas that is present in a predetermined space becomes low (for example, about 0 ppm).

(Difference from PTL 3)

The carbonic acid gas absorbent material disclosed in PTL 3, the carbonic acid gas absorbent material containing a lithium silicate as a main component, absorbs water together with carbon dioxide. In addition, as described above, it is obvious from the safety data sheet that this lithium silicate exhibits insolubility in water. Accordingly, when carbon dioxide is separated from a gas containing water and carbon dioxide and absorbed, the carbonic acid gas absorbent material disclosed in PTL 3 absorbs water together with carbon dioxide, resulting in a problem of a decrease in the amount of absorption of carbon dioxide per unit weight.

Furthermore, as described above, the carbonic acid gas absorbent material disclosed in PTL 3 contains a particular amount of water. Therefore, the amount of water contained in the carbonic acid gas absorbent material is changed by absorbing water from the gas together with carbon dioxide, resulting a problem in that the carbonic acid gas absorbent material cannot absorb carbon dioxide when the content of water exceeds the particular amount.

In contrast, the carbon dioxide absorbent material 10 contains a tetravalent lithium silicate that exhibits water solubility. That is, the carbon dioxide absorbent material 10 is not a carbon dioxide absorbent material obtained by adding a particular amount of water to a lithium silicate that exhibits insolubility in water, as in the carbonic acid gas absorbent material disclosed in PTL 3. Furthermore, as described above, the tetravalent lithium silicate that exhibits water solubility absorbs carbon dioxide in the gas on the basis of a mechanism different from a mechanism for absorbing carbon dioxide by the lithium silicate disclosed in PTL 3, the lithium silicate exhibiting insolubility in water. That is, unlike the lithium silicate that exhibits insolubility in water, in the tetravalent lithium silicate that exhibits water solubility, absorption of carbon dioxide is not inhibited by absorption of water. Therefore, the carbon dioxide absorbent material 10 solves the problems described above and can absorb carbon dioxide for a long time even in the case where a gas contains water.

In the method for producing a lithium silicate disclosed in PTL 3, particular amounts of silicon dioxide and lithium carbonate are weighed and then mixed in an agate mortar. In contrast, in the method for producing the carbon dioxide absorbent material 10, silicon dioxide and lithium carbonate are mixed by using a three-dimensional mill instead of using an agate mortar. The method for producing a lithium silicate in the present application differs from the method for producing a lithium silicate in PTL 3 in this point.

Note that the method for producing a lithium silicate disclosed in PTL 3 describes an ordinary production method. PTL 3 does not disclose that various lithium silicates were produced under all the conditions within the ranges of the amount of mixing, mixing time, heating time, and heating temperature disclosed therein. In general, it is known that characteristics of ceramics can be changed by changing various conditions for production. As a result of extensive studies, the inventors of the present invention found that a tetravalent lithium silicate that exhibits water solubility, which is different from the lithium silicate disclosed in PTL 3, the lithium silicate exhibiting insolubility in water, can be obtained by the production method described above.

(Field of Application of Carbon Dioxide Absorbent Material 10)

The carbon dioxide absorbent material 10 can be used in an environment in which carbon dioxide contained in a gas is required to be absorbed, for example, in an environment in which carbon dioxide is generated. Specifically, the carbon dioxide absorbent material 10 can be used for removing carbon dioxide produced from living organisms such as humans in the human living space in which air is present. From this point of view, the carbon dioxide absorbent material 10 can be suitably used in electronic devices, such as an air cleaner, a humidifier, and a dehumidifier, all of which are used in the living space. Furthermore, as described above, the carbon dioxide absorbent material 10 effectively functions in an environment in which a gas contains water. In light of this point, the carbon dioxide absorbent material 10 can be suitably used in the electronic devices.

In addition to the above, the carbon dioxide absorbent material 10 can be used in, for example, a spaceship or submarine having a space hermetically sealed from the external environment. The carbon dioxide absorbent material 10 can be installed in an analytical instrument in which carbon dioxide needs to be removed from air taken therein or used in a room in which the analytical instrument is installed. Furthermore, the carbon dioxide absorbent material 10 can also be used in an environment in which fossil fuels that generate carbon dioxide are combusted (for example, a plant).

The carbon dioxide absorbent material 10 may be used in the various environments in the form applied to a pellet 20 or a filter 30 in Embodiment 2.

### Embodiment 2

A description of another embodiment of the present invention will be given as follows with reference to FIG. 6. For the sake of convenience of the description, components having the same functions as components described in the above embodiment are assigned the same reference numerals, and a description thereof is omitted. Part (a) and part (b) of FIG. 6 are views illustrating an example of a filter 30 according to this embodiment. Specifically, part (b) of FIG. 6 is an enlarged view of the relevant part of the filter 30 illustrated in part (a) of FIG. 6.

<Pellet 20>

Pellets 20 absorb carbon dioxide contained in a gas and contain the carbon dioxide absorbent material 10 described in Embodiment 1, the carbon dioxide absorbent material 10 containing the tetravalent lithium silicate that exhibits water solubility. The pellets 20 are a pelletized product that is obtained by hardening the powdery carbon dioxide absorbent material 10 and that has a size larger than the size of the carbon dioxide absorbent material 10. In this embodiment, the pellets 20 are a pelletized product produced by forming the powdery carbon dioxide absorbent material 10 to have a substantially spherical shape, as illustrated in part (b) of FIG. 6.

Examples of the shape of the pellets 20 include various shapes such as a column and a rectangular parallelepiped besides a substantially spherical shape. Considering that the pellets 20 are contained in a filter 30, which will be described below, the pellets 20 preferably have such a shape and a size that a pressure loss can be reduced when contained in the filter 30. In this case, the pellets 20 preferably have a size of, for example, about several millimeters.

<Method for Producing Pellet 20>

An example of a method for producing the pellet 20 will be described.

First, the carbon dioxide absorbent material 10 produced by the production method described in Embodiment 1 and a binder are mixed (binder mixing step). Subsequently, the resulting mixture of the carbon dioxide absorbent material 10 and the binder is placed in a predetermined mold and sintered at a predetermined temperature (sintering step). Consequently, pellets 20 that contain the carbon dioxide absorbent material 10, which is a powder, and that are larger than the carbon dioxide absorbent material 10 are produced.

<Filter 30>

The filter 30 is a filter that absorbs carbon dioxide contained in a gas. The filter 30 is a particle-filling type filter, the interior of which can be filled with the powdery carbon dioxide absorbent material 10 so as to absorb the carbon dioxide. In this embodiment, as illustrated in part (a) and part (b) of FIG. 6, the filter 30 contains the above-described pellets 20 therein instead of the powdery carbon dioxide absorbent material 10.

Specifically, the filter 30 includes pellets 20 and dustproof filters 35 therein. The filter 30 has two openings. An insertion pipe 36 and a discharge pipe 37 are connected to the openings. The insertion pipe 36 is a pipe through which a gas containing water and carbon dioxide passes and the gas is inserted into the interior of the filter 30. The discharge pipe 37 is a pipe through which the gas after the carbon dioxide is partially absorbed (removed) by the filter 30 passes and the gas is discharged to the outside of the filter 30.

The dustproof filters 35 prevent dust and the like from entering the interior of the filter 30 from the insertion pipe 36 and the discharge pipe 37. The dustproof filters 35 are disposed inside the filter 30 so as to cover at least the openings. One of the dustproof filters 35 that covers the opening on the insertion pipe 36 side has a function of dispersing the gas from the insertion pipe 36 into the interior of the filter 30 and preventing the pellets 20 from leaking out from the opening into the insertion pipe 36. The other dustproof filter 35 that covers the opening on the discharge pipe 37 side has a function preventing the pellets 20 from leaking out from the opening into the discharge pipe 37.

The interior of the filter 30 is filled with the pellets 20. The gas containing water and carbon dioxide passes through the insertion pipe 36 and is inserted into the interior of the filter 30. Carbon dioxide in the gas is absorbed by the pellets 20 in the filter 30, and the gas after the absorption of carbon dioxide is discharged from the discharge pipe 37 to the outside thereof. This structure enables the gas from which carbon dioxide has been removed to be supplied to the space outside the filter 30.

### Main Advantages of this Embodiment

As described above, the pellets 20 contain the carbon dioxide absorbent material 10 containing the tetravalent lithium silicate that exhibits water solubility. Therefore, as in Embodiment 1, carbon dioxide can be absorbed from a gas containing water and carbon dioxide for a long time. That is, the pellets 20 can suppress a decrease in absorption efficiency of carbon dioxide contained in a gas even in the case where the gas contains water. The pellets 20 are obtained by hardening the powdery carbon dioxide absorbent material 10 and are a pelletized product larger than the carbon dioxide absorbent material 10. Therefore, multiplicity of use of the powdery carbon dioxide absorbent material 10 can be improved.

Furthermore, the filter 30 contains the pellets 20 therein, the pellets 20 containing the carbon dioxide absorbent material 10.

Here, even in the case where the interior of the filter 30 is filled with the powdery carbon dioxide absorbent material 10 without further treatment, in the filter 30, carbon dioxide can be absorbed from a gas that contains water and carbon dioxide and that is inserted from the insertion pipe 36. However, when a carbon dioxide absorbent material is a powder (in particular, having a particle size on the order of micrometers) and the powder is contained in the filter 30, a pressure loss increases due to a decrease in gaps between the powder particles, resulting in clogging. In this case, carbon dioxide from the insertion pipe 36 cannot pass through the interior of the filter 30, and carbon dioxide may not be absorbed by the whole of the carbon dioxide absorbent material 10 contained in the filter 30.

Since the pellets 20 are produced by pelletization so as to be larger than the powdery carbon dioxide absorbent material 10, the gaps between the pellets 20 can be made larger than those in the case where a powder is contained in the filter 30. Therefore, the generation of the pressure loss can be suppressed, and carbon dioxide can be absorbed by the whole of the carbon dioxide absorbent material 10 (that is, the pellets 20) contained in the filter 30.

That is, instead of the powdery carbon dioxide absorbent material 10, which has been difficult to apply to the filter 30 because the pressure loss increases, the pellets 20 are contained in the filter 30. This enables the carbon dioxide absorbent material 10 to be applied to the filter 30. Accordingly, also in the filter 30, carbon dioxide can be efficiently absorbed from a gas containing water and carbon dioxide at a low cost for a long time. That is, even in the case where a gas contains water, the filter 30 can suppress a decrease in absorption efficiency of carbon dioxide contained in the gas.

### Embodiment 3

An embodiment of the present invention will now be described in detail with reference to FIGS. 7 to 15.

<Carbon Dioxide Absorbent Material 10a>

FIG. 7 is a view illustrating an example of a measurement mechanism that measures a concentration of carbon dioxide in a container 12, according to this embodiment. Specifically, the measurement mechanism illustrated in FIG. 7 measures an amount of carbon dioxide absorbed by a carbon dioxide absorbent material 10a or the like. Measurement results obtained by the measurement mechanism will be described below as Examples.

The carbon dioxide absorbent material 10a of the embodiment illustrated in FIG. 7 can absorb carbon dioxide contained in a gas. Specifically, the carbon dioxide absorbent material 10a can separate at least part of carbon dioxide from a gas containing water (that is, water vapor) and carbon dioxide (that is, carbonic acid gas) and absorb the carbon dioxide. The carbon dioxide absorbent material 10a contains a tetravalent lithium silicate (Li₄SiO₄) that exhibits water solubility.

The carbon dioxide absorbent material 10a of Examples, which will be described below, is mostly formed of a tetravalent lithium silicate that exhibits water solubility and contains the lithium silicate as a main component. As in Embodiment 1, when a ratio of the tetravalent lithium silicate that exhibits water solubility to all the substances contained in the carbon dioxide absorbent material 10a is, for example, 80% or more, the lithium silicate is assumed to be a main component of the carbon dioxide absorbent material 10a.

The carbon dioxide absorbent material 10a contains potassium carbonate (K₂CO₃). Specifically, the carbon dioxide absorbent material 10a is obtained by adding potassium carbonate to the tetravalent lithium silicate that exhibits water solubility. In the carbon dioxide absorbent material 10a, a molar ratio of potassium carbonate to the tetravalent lithium silicate that exhibits water solubility is 0.01 or more and 0.1 or less. That is, in the carbon dioxide absorbent material 10a, the amount of potassium carbonate added to the tetravalent lithium silicate that exhibits water solubility is 1% by mole or more and 10% by mole or less.

Here, in general, tetravalent lithium silicates exhibit insolubility in water as described in Embodiment 1. However, as a result of extensive studies, the inventors of the present invention found that a tetravalent lithium silicate that exhibits water solubility can be obtained. Furthermore, as a result of extensive studies, the inventors of the present invention found that the absorption rate of carbon dioxide in the gas can be increased in the carbon dioxide absorbent material 10a by adding a particular amount of potassium carbonate to the tetravalent lithium silicate that exhibits water solubility.

### EXAMPLES

Next, a description will be given of a method for producing the carbon dioxide absorbent material 10a and absorption characteristics of the carbon dioxide absorbent material 10a produced by the production method. In addition, a description will be given of the relationship between the amount of potassium carbonate contained in the carbon dioxide absorbent material 10a produced by the production method and an absorption rate of carbon dioxide in the gas, the carbon dioxide being absorbed by the carbon dioxide absorbent material 10a.

(Method for Producing Carbon Dioxide Absorbent Material 10a)

An example of a method for producing the carbon dioxide absorbent material 10a will be described. The method for producing a tetravalent lithium silicate is the same as the method described in Embodiment 1. Specifically, the tetravalent lithium silicate that exhibits water solubility is produced as in Embodiment 1 through the weighing step, the mixing step, the heating step, and the crushing step described above.

The tetravalent lithium silicate obtained through the crushing step is referred to as a “sample A”. Samples are prepared by adding, to the sample A, potassium carbonate in an amount of 1% by mole, 5% by mole, 10% by mole, and 20% by mole (addition step). The sample prepared by adding, to the sample A, potassium carbonate in an amount of 1% by mole is referred to as a “sample B”. The sample prepared by adding, to the sample A, potassium carbonate in an amount of 5% by mole is referred to as a “sample C”. The sample prepared by adding, to the sample A, potassium carbonate in an amount of 10% by mole is referred to as a “sample D”. The sample prepared by adding to the sample A, potassium carbonate in an amount of 20% by mole is referred to as a “sample E”. Specifically, the molar ratio of potassium carbonate to the tetravalent lithium silicate in the sample B is 0.01, the molar ratio in the sample C is 0.05, the molar ratio in the sample D is 0.1, and the molar ratio in the sample E is 0.2. Carbon dioxide absorbent materials in which potassium carbonate is added to the tetravalent lithium silicate that exhibits water solubility are produced in this manner. Note that, among the samples A to E, the samples B, C, and D function as the carbon dioxide absorbent material 10a.

(Identification and Examination of Water Solubility)

The inventors of the present invention examined whether or not a substance actually produced by the production method described above was a tetravalent lithium silicate by identifying the substance with an X-ray diffractometer. Here, the substance refers to the tetravalent lithium silicate (sample A) before potassium carbonate is added, the tetravalent lithium silicate being produced by the production method described above. That is, an example of the measurement results of the carbon dioxide absorbent material 10a according to this embodiment, the measurement results being obtained with the X-ray diffractometer, is identical to the graph shown in FIG. 2. Accordingly, the above substance can be identified as a tetravalent lithium silicate as in Embodiment 1. That is, the carbon dioxide absorbent material 10a produced by the production method described above can be determined as a substance containing a tetravalent lithium silicate as a main component.

A method for examining whether or not the tetravalent lithium silicate produced by the production method is water-soluble has also been described in Embodiment 1, and thus a description thereof is omitted here.

(Absorption Characteristics of Carbon Dioxide Absorbent Material 10a)

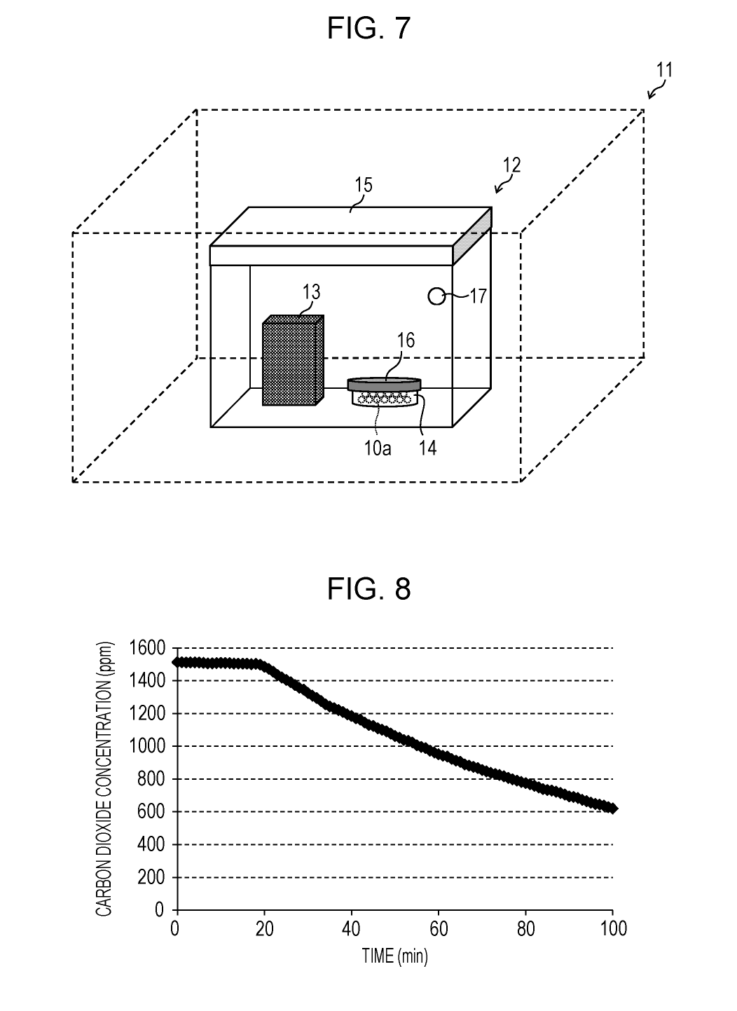

Next, examination results of absorption characteristics of the carbon dioxide absorbent material 10a produced by the production method described above will be described with reference to FIGS. 7 to 14. FIGS. 8 to 12 are graphs each showing an example of a change in the concentration of carbon dioxide in the container 12 with time, the concentration being measured with the measurement mechanism illustrated in FIG. 7.

The measurement mechanism illustrated in FIG. 7 measures an amount of carbon dioxide absorbed by a carbon dioxide absorbent material such as the carbon dioxide absorbent material 10a produced by the production method described above and includes a constant temperature and humidity chamber 11, a container 12, a concentration measurement device 13, and a sample container 14. This measurement mechanism actually measures a concentration of carbon dioxide in a gas contained in the container 12, to thereby measure the amount of carbon dioxide absorbed by the carbon dioxide absorbent material.

The constant temperature and humidity chamber 11 can maintain the interior thereof at a predetermined temperature and a predetermined humidity. The container 12 is placed in the constant temperature and humidity chamber 11.

The container 12 is filled with a gas containing water and carbon dioxide and capable of making a measurement environment therein. The container 12 is provided with a cover 15 on an upper portion thereof. In this Example, the material of the container 12 is an acrylic resin. However, the material is not particularly limited as long as the container 12 can provide the above measurement environment. An inlet 17 for injecting carbon dioxide (carbonic acid gas) into the container 12 is formed in a sidewall of the container 12. The inlet 17 is configured to be openable and closable such that the inlet 17 is opened only when carbonic acid gas is injected and the inlet 17 is closed at other times.

The concentration measurement device 13 measures the concentration of carbon dioxide in a gas contained in the container 12 in a state hermetically sealed by closing the cover 15 and is installed in the container 12.

The sample container 14 is used for placing a carbon dioxide absorbent material therein and placed in the container 12. The sample container 14 is provided with a cover 16 on an upper portion thereof.

A measurement method of this embodiment is as follows. The interior of the constant temperature and humidity chamber 11 has the same atmosphere as the air. The temperature of the interior of the constant temperature and humidity chamber 11 is set to 20° C., and the humidity thereof is set to 50% RH (relative humidity). The acrylic container 12 having an internal volume of 2.2 L is placed in the constant temperature and humidity chamber 11 set as described above in a state where the cover 15 is opened. The constant temperature and humidity chamber 11 and the container 12 were left to stand for about 30 minutes in this state. Thereby, the temperature and the humidity of the interior of the constant temperature and humidity chamber 11 were made close to 20° C. and 50% RH, respectively, which were set as described above, and the atmosphere of the interior of the container 12 was made the same as the atmosphere of the interior of the constant temperature and humidity chamber 11.

Next, in the constant temperature and humidity chamber 11, 0.8 g of the sample A produced as described above is placed in the sample container 14, and the sample container 14 is simply hermetically sealed by closing the cover 16. Subsequently, in the constant temperature and humidity chamber 11, the sample container 14 that has been simply hermetically sealed is placed in the container 12, and the container 12 is hermetically sealed by closing the cover 15.

In this state, carbon dioxide (carbonic acid gas) is injected from the inlet 17 into the interior of the container 12. The carbonic acid gas is injected until the concentration of carbon dioxide in the container 12 becomes about 1,500 ppm. Subsequently, the inlet 17 is closed and a door of the constant temperature and humidity chamber 11 is also closed. From this point of time, measurement of the concentration of carbon dioxide contained in the container 12 with time was started with the concentration measurement device 13. The constant temperature and humidity chamber 11 and the container 12 were then left to stand for about 20 minutes in this state.

Subsequently, the door of the constant temperature and humidity chamber 11 and the cover 15 of the container 12 were opened, and the cover 16 of the sample container 14 containing the sample A therein was opened from the outside of the container 12. Subsequently, the cover 15 of the container 12 and the door of the constant temperature and humidity chamber 11 were closed to hermetically seal the interior of the container 12. Subsequently, the concentration of carbon dioxide contained in the container 12 was continuously measured with time with the concentration measurement device 13.

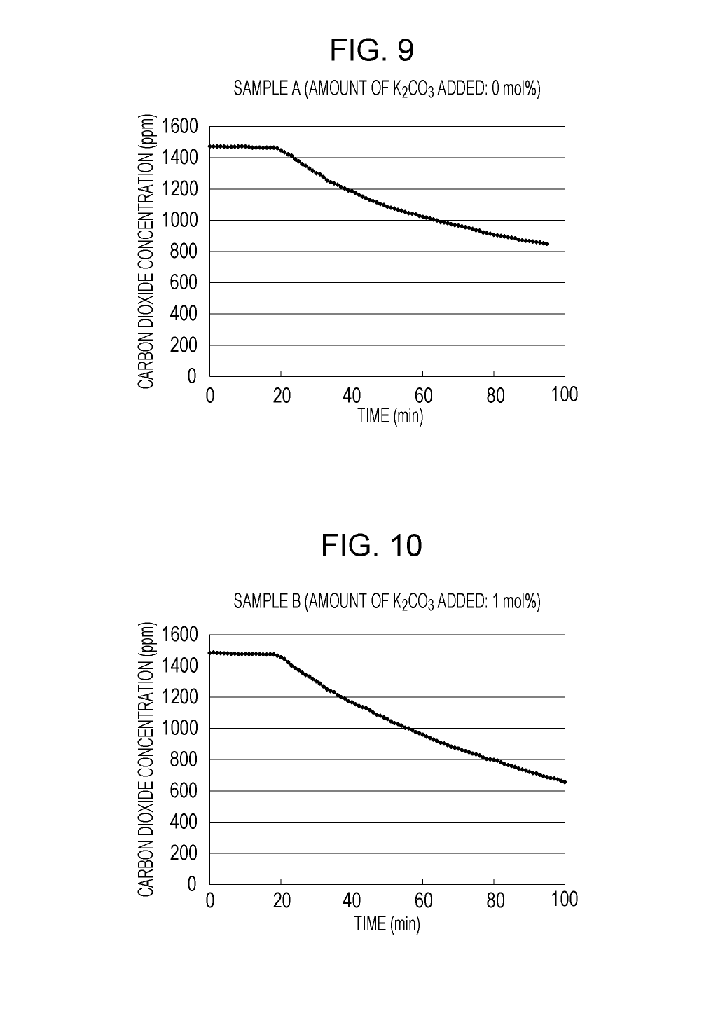

A measurement method when the sample A is placed in the sample container 14 has been described above. Similarly, for each of the samples B to E, the concentration of carbon dioxide was measured with time in accordance with the measurement method described above. FIGS. 8 to 12 show the measurement results. FIG. 8 shows the measurement results of the sample C as an example of the measurement results. FIGS. 9 to 12 show the measurement results of the samples A, B, D, and E, respectively.

For about 20 minutes from the start of the measurement, the cover 16 of the sample container 14 is closed. Therefore, as shown in FIGS. 8 to 12, a change in the concentration of carbon dioxide in the container 12 is not observed during the time. Subsequently, after the cover 16 of the sample container 14 is opened, the concentration of carbon dioxide in the container 12 continues to decrease, as shown in FIGS. 8 to 12. The inventors of the present invention confirmed that the concentration of carbon dioxide in the container 12 continued to decrease for a long time in each of the samples A to E.

For a while after the opening of the cover 16 (in this Example, for about ten and several minutes as shown in FIGS. 8 to 12), the concentration of carbon dioxide contained in the container 12 rapidly decreases compared with the subsequent period. This is presumably due to absorption of carbon dioxide by the carbon dioxide absorbent material 10a and physical adsorption of carbon dioxide on the surface of the carbon dioxide absorbent material 10a.

Thereafter, the amount of decrease in the concentration of carbon dioxide per unit time becomes smaller than the amount of decrease per unit time during the above period after the opening of the cover 16. However, the concentration of carbon dioxide continues to decrease. Considering that the concentration of carbon dioxide contained in the container 12 also decreases with time, it is considered that the concentration of carbon dioxide continues to decrease at a substantially constant ratio. That is, the carbon dioxide absorption rate of the carbon dioxide absorbent material 10a (the slope of each of the graphs shown in FIGS. 8 to 12) is considered to be substantially constant after the above period elapses from the opening of the cover 16.

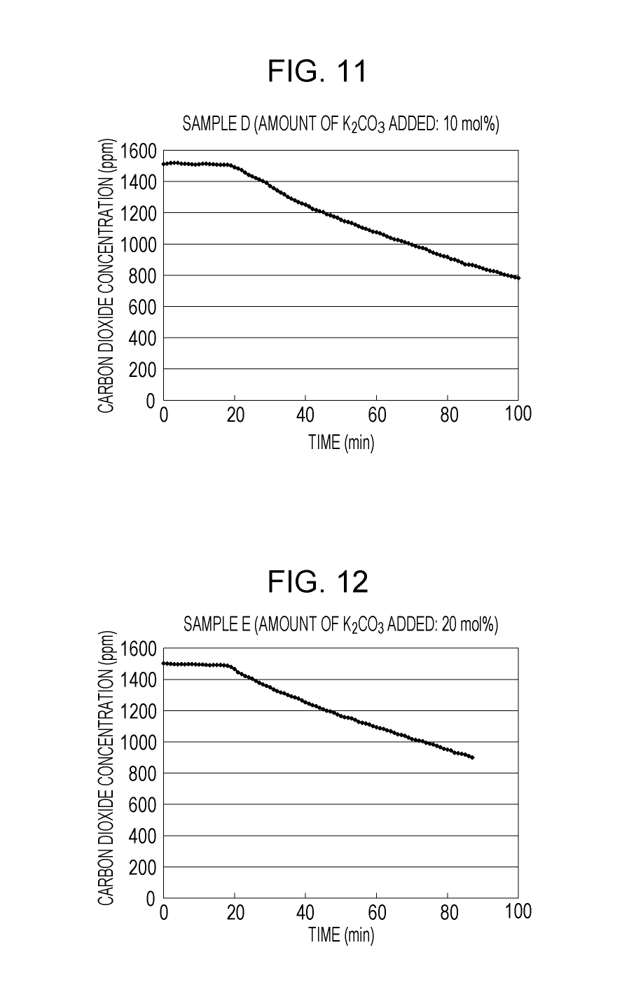

The concentration of carbon dioxide in the sample A (amount of potassium carbonate added: 0% by mole) exceeds 850 ppm after 90 minutes elapses from the start of the measurement, as shown in FIG. 9. The concentrations of carbon dioxide in the sample B (addition amount: 1% by mole) and the sample C (addition amount: 5% by mole) are significantly lower than 800 ppm after 90 minutes elapses from the start of the measurement, as shown in FIGS. 10 and 8, respectively. The concentration of carbon dioxide in the sample D (addition amount: 10% by mole) is lower than 850 ppm after 90 minutes elapses from the start of the measurement, as shown in FIG. 11. On the other hand, the concentration of carbon dioxide in the sample E (addition amount: 20% by mole) is presumably about 900 ppm after 90 minutes elapses from the start of the measurement, as shown in FIG. 12.

These results show that the concentration of carbon dioxide continues to decrease because the carbon dioxide absorbent material 10a contains the tetravalent lithium silicate. The results show that when the carbon dioxide absorbent material 10a further contains potassium carbonate such that the molar ratio of potassium carbonate to the tetravalent lithium silicate becomes 0.01 or more and 0.1 or less (the amount of potassium carbonate added becomes 1% by mole or more and 10% by mole or less), the concentration of carbon dioxide efficiently decreases.

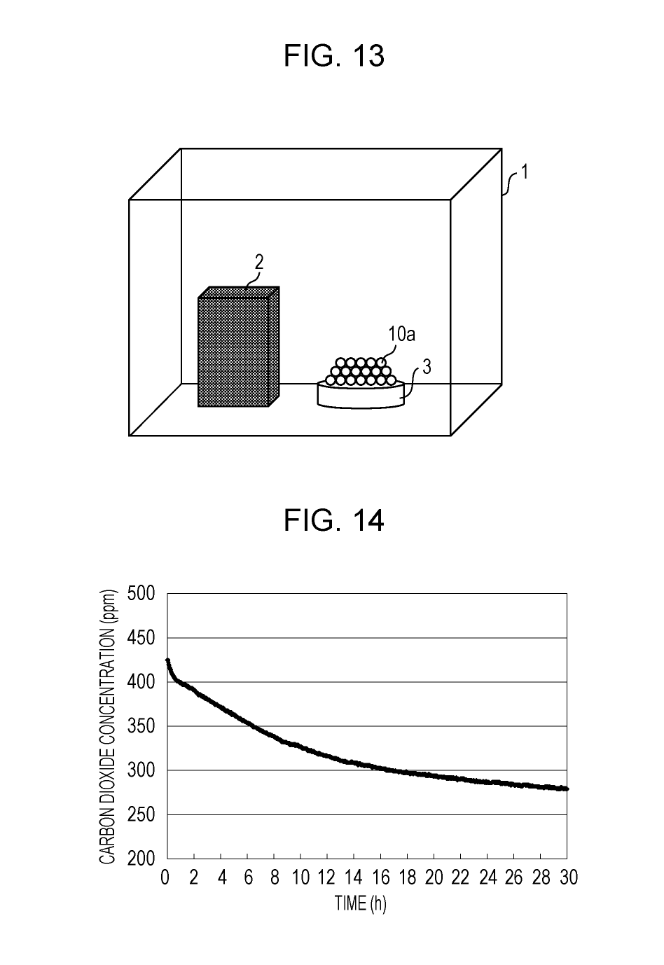

Here, carbon dioxide absorption durability of the carbon dioxide absorbent material 10a will be described with reference to FIGS. 13 and 14. FIG. 13 is a view illustrating another example of a measurement mechanism that measures a concentration of carbon dioxide in a container 1, according to this embodiment. FIG. 14 is a graph showing an example of a change in the concentration of carbon dioxide in the container 1 with time, the concentration being measured with the measurement mechanism illustrated in FIG. 13. The measurement mechanism illustrated in FIG. 13 measures an amount of carbon dioxide absorbed by a carbon dioxide absorbent material such as the carbon dioxide absorbent material 10a. The measurement mechanism illustrated in FIG. 13 has the same configuration as the measurement mechanism illustrated in FIG. 1 of Embodiment 1, and thus a description thereof is omitted.

A measurement method in an Example for examining the absorption durability is as follows. First, an acrylic container 1 having an internal volume of 12 L was placed in air at a temperature of 24° C. and a humidity of 40% RH, so that the interior of the container 1 had an atmosphere that was the same as the air. Subsequently, 0.02 g of the carbon dioxide absorbent material 10a which was, for example, the sample D was placed on a dish 3, and the dish 3 was placed in the container 1. Subsequently, the cover of the container 1 was closed to hermetically seal the interior of the container 1. In this state, the concentration of carbon dioxide contained in the container 1 was measured with a concentration measurement device 2 with time. FIG. 14 shows the measurement results.

As shown in FIG. 14, the results show that the concentration of carbon dioxide in the container 1 continues to decrease for about 30 hours from the start of the measurement. In this Example, the rapid decrease in the concentration of carbon dioxide for a while from the start of the measurement is presumably due to absorption of carbon dioxide by the carbon dioxide absorbent material 10a and physical adsorption of carbon dioxide on the surface of the carbon dioxide absorbent material 10a as described in Embodiment 1. In addition, as described in Embodiment 1, a carbon dioxide absorption rate of the carbon dioxide absorbent material 10a (the slope of the graph shown in FIG. 14) is considered to be substantially constant after the above period elapses from the start of the measurement.

(Absorption Rate Characteristics of Carbon Dioxide Absorbent Material 10a)

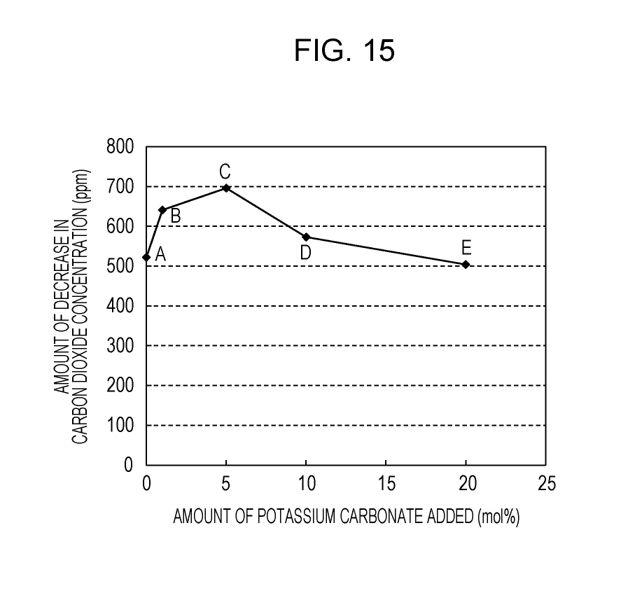

Next, absorption rate characteristics of the carbon dioxide absorbent material 10a will be described with reference to FIG. 15. FIG. 15 is a graph showing an example of the relationship between an amount of potassium carbonate added to the tetravalent lithium silicate that exhibits water solubility and an amount of decrease in the concentration of carbon dioxide per predetermined time.

Specifically, for each of the samples A to E, the difference between the concentration of carbon dioxide in the container 12 after about 5 minutes from the opening of the cover 16 of the sample container 14 and the concentration of carbon dioxide in the container 12 after about 1 hour from the opening of the cover 16 was calculated on the basis of the results of the measurement. This difference represents an amount of decrease in the concentration of carbon dioxide in the container 12 during the period of about 55 minutes and corresponds to the carbon dioxide absorption rate of each of the samples A to E. For each of the samples A to E, the amount of decrease (the difference) was plotted to obtain a graph showing the dependence of the amount of decrease on the amount of potassium carbonate added, as shown in FIG. 15. Symbols “A” to “E” in FIG. 15 denote the samples A to E, respectively, and show that the dots in FIG. 15 are obtained from the measurement results of the samples A to E, respectively.

As shown in FIG. 15, when potassium carbonate is not added (0% by mole; sample A), the amount of decrease in the concentration of carbon dioxide is about 520 ppm.

On the other hand, the amounts of decrease of the sample B in which potassium carbonate is added in an amount of 1% by mole, the sample C in which potassium carbonate is added in an amount of 5% by mole, and the sample D in which potassium carbonate is added in an amount of 10% by mole are about 650 ppm, about 700 ppm, and about 580 ppm, respectively. Thus, FIG. 15 shows that the amounts of decrease of the samples B, C, and D are each larger than the amount of decrease of the Sample A. That is, the results show that each of the samples B, C, and D has a higher absorption rate of carbon dioxide than the case where potassium carbonate is not added.

In contrast, the amount of decrease of the sample E in which potassium carbonate is added in an amount of 20% by mole is about 500 ppm, which is smaller than the amount of decrease of the sample A. Specifically, unlike the samples B, C, and D, regarding the sample E, the effect of increasing the absorption rate of carbon dioxide is not observed.

As described above, when a particular amount of potassium carbonate is added to the tetravalent lithium silicate that exhibits water solubility, the absorption rate of carbon dioxide from a gas containing water and carbon dioxide can be increased compared with the case where potassium carbonate is not added. Specifically, FIG. 15 shows that when the molar ratio of potassium carbonate to the tetravalent lithium silicate is 0.01 or more and 0.1 or less, the absorption rate of carbon dioxide can be increased compared with the case where potassium carbonate is not added. That is, the samples B, C, and D function as the carbon dioxide absorbent material 10a.

<Principle of Increase in Absorption Rate>

As described above, the absorption rate of carbon dioxide in the gas can be increased by adding potassium carbonate in an amount of 1% by mole or more and 10% by mole or less relative to the tetravalent lithium silicate that exhibits water solubility. However, the principle of an increase in the absorption rate of carbon dioxide in the gas (the mechanism of an increase in the absorption rate) due to the addition of a particular amount of potassium carbonate to the tetravalent lithium silicate that exhibits water solubility has not yet been made clear at the time of filing of the basic application of the present application. The inventors of the present invention assume that an example of the principle of an increase in the absorption rate is as follows.

Potassium carbonate is a deliquescent material. As described above, it is believed that when water adheres to a surface of the tetravalent lithium silicate that exhibits water solubility, the surface becomes in a molten state, and permeation of carbon dioxide inside the carbon dioxide absorbent material 10a is facilitated. Accordingly, when deliquescent potassium carbonate is contained in the carbon dioxide absorbent material 10a and water adheres to a surface of the tetravalent lithium silicate, presumably, the potassium carbonate functions so as to promote the melting of the surface and allows the surface to be in a state in which carbon dioxide more easily permeates. It is believed that the carbon dioxide absorption rate of the tetravalent lithium silicate to which potassium carbonate is added increases accordingly.

As described above, it is presumable that a reaction proceeds on the surface while water functions as a catalyst, and carbon dioxide in the gas is thereby absorbed. Also in this case, presumably, since potassium carbonate has a deliquescence property, the potassium carbonate functions so as to further promote the reaction, and the absorption rate of carbon dioxide increases.

The absorption principle (mechanism of absorption) of carbon dioxide in the gas by the tetravalent lithium silicate that exhibits water solubility is as described in Embodiment 1.

### Main Advantages of this Embodiment

The carbon dioxide absorbent material 10a of this embodiment contains a tetravalent lithium silicate that exhibits water solubility. Therefore, the carbon dioxide absorbent material 10a provides the same advantages as those achieved by the carbon dioxide absorbent material 10 of Embodiment 1.

Furthermore, the carbon dioxide absorbent material 10a contains potassium carbonate. The molar ratio of potassium carbonate to the tetravalent lithium silicate that exhibits water solubility is 0.01 or more and 0.1 or less.

In this case, the absorption rate of carbon dioxide in the gas can be increased in the carbon dioxide absorbent material 10a compared with the case where potassium carbonate is not added to the tetravalent lithium silicate.

Therefore, the amount of carbon dioxide that can be separated from a gas containing water and carbon dioxide and absorbed within a predetermined time can be increased per unit weight of the material.

Accordingly, the carbon dioxide absorbent material 10a can separate carbon dioxide from the gas and absorb the carbon dioxide within a predetermined time in a small amount compared with the case where potassium carbonate is not added.

Furthermore, since the carbon dioxide absorbent material 10a can increase the absorption rate of carbon dioxide, it is possible to prevent an increase in the size of a carbon dioxide-absorbing mechanism for promoting the absorption of carbon dioxide. Therefore, the cost for arranging the carbon dioxide-absorbing mechanism and the cost for operating the carbon dioxide-absorbing mechanism can be reduced. The installation site of the carbon dioxide-absorbing mechanism can also be reduced.

Accordingly, the carbon dioxide absorbent material 10a provides, besides the advantages achieved by the tetravalent lithium silicate that exhibits water solubility, an advantage that carbon dioxide in the gas can be efficiently absorbed at a low cost compared with the case where potassium carbonate is not added. That is, the carbon dioxide absorbent material 10a can suppress a decrease in the absorption efficiency of carbon dioxide contained in a gas and further increase the absorption efficiency even in the case where the gas contains water.

(Difference from PTL 3)

The difference between the carbonic acid gas absorbent material disclosed in PTL 3, the carbonic acid gas absorbent material containing a lithium silicate as a main component, and the carbon dioxide absorbent material 10a of this embodiment lies in the point described below in addition to the difference between the carbonic acid gas absorbent material and the carbon dioxide absorbent material 10 described in Embodiment 1.

PTL 3 discloses an example in which a particular amount of water is added to a lithium silicate that exhibits insolubility in water and potassium carbonate is added thereto. However, since the carbonic acid gas absorbent material disclosed in PTL 3 does not contain the tetravalent lithium silicate that exhibits water solubility, the way of action of potassium carbonate to the lithium silicate is presumably different. That is, in the carbon dioxide absorbent material 10a, when water adheres to a surface of the tetravalent lithium silicate that exhibits water solubility, potassium carbonate presumably functions so as to promote the melting of the surface, as described above. However, since the lithium silicate disclosed in PTL 3 is insoluble in water, as a matter of course, the melting of a surface of the lithium silicate due to adhesion of water does not occur. Accordingly, as a matter of course, it is believed that potassium carbonate added to the lithium silicate disclosed in PTL 3 does not function so as to promote the melting of the surface.

(Field of Application of Carbon Dioxide Absorbent Material 10a)

Fields of application of the carbon dioxide absorbent material 10a are the same as those of the carbon dioxide absorbent material 10 in Embodiment 1. Hereinafter, in Embodiment 4, a description will be given of a case where the carbon dioxide absorbent material 10a is applied to a pellet 20 or a filter 30.

### Embodiment 4

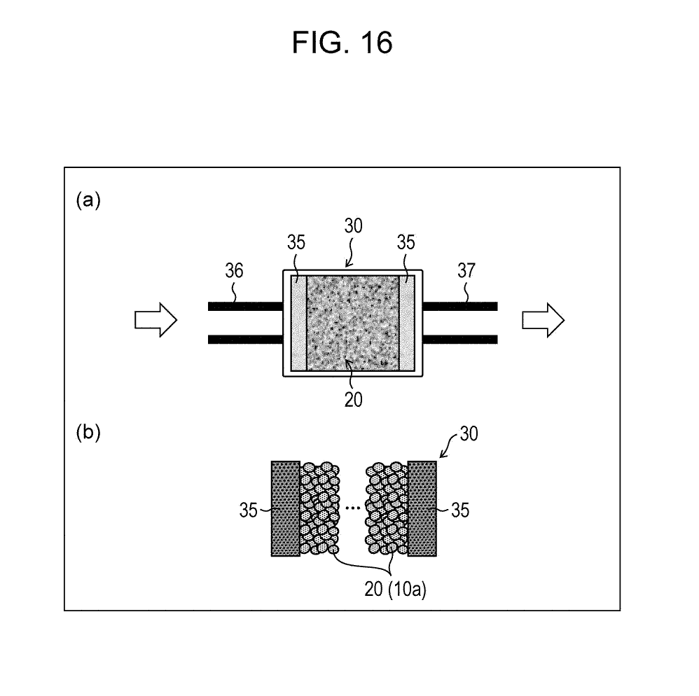

A description of another embodiment of the present invention will be given as follows with reference to FIG. 16. For the sake of convenience of the description, components having the same functions as components described in the above embodiments are assigned the same reference numerals, and a description thereof is omitted. Part (a) and part (b) of FIG. 16 are views illustrating an example of a filter 30 according to this embodiment. Specifically, part (b) of FIG. 16 is an enlarged view of the relevant part of the filter 30 illustrated in part (a) of FIG. 16.

<Pellet 20>

Pellets 20 absorb carbon dioxide contained in a gas. The pellets 20 contain the carbon dioxide absorbent material 10a described in Embodiment 3, the carbon dioxide absorbent material 10a containing the tetravalent lithium silicate that exhibits water solubility and potassium carbonate (where a molar ratio of potassium carbonate to the lithium silicate is 0.01 or more and 0.1 or less). The pellets 20 are a pelletized product that is obtained by hardening the powdery carbon dioxide absorbent material 10a and that has a size larger than the size of the carbon dioxide absorbent material 10a. In this embodiment, the pellets 20 are a pelletized product produced by forming the powdery carbon dioxide absorbent material 10a to have a substantially spherical shape, as illustrated in part (b) of FIG. 16.

Other features such as the shape, the size, and a production method of the pellets 20 are similar to those of the pellets 20 of Embodiment 2, and thus a description thereof is omitted here.

<Filter 30>

The filter 30 is a filter that absorbs carbon dioxide contained in a gas. The filter 30 is a particle-filling type filter, the interior of which can be filled with the powdery carbon dioxide absorbent material 10a so as to absorb the carbon dioxide. In this embodiment, as illustrated in part (a) and part (b) of FIG. 16, the filter 30 contains the above-described pellets 20 therein instead of the powdery carbon dioxide absorbent material 10a. The specific structure of the filter 30 is the same as that of the filter 30 of Embodiment 2, and thus a description thereof is omitted here.

### Main Advantages of this Embodiment

As described above, the pellets 20 contain the carbon dioxide absorbent material 10a containing a tetravalent lithium silicate that exhibits water solubility and potassium carbonate (where a molar ratio of potassium carbonate to the lithium silicate is 0.01 or more and 0.1 or less). Therefore, as in Embodiment 3, carbon dioxide can be absorbed from a gas containing water and carbon dioxide for a long time. That is, even in the case where a gas contains water, the pellets 20 can suppress a decrease in absorption efficiency of carbon dioxide contained in the gas and further increase the absorption efficiency. In addition, the pellets 20 enable multiplicity of use of the powdery carbon dioxide absorbent material 10a to improve for the same reason as that in Embodiment 2.

Furthermore, the filter 30 contains the pellets 20 therein, the pellets 20 containing the carbon dioxide absorbent material 10a. Therefore, for the same reason as that in Embodiment 2, also in the filter 30, carbon dioxide can be efficiently absorbed from a gas containing water and carbon dioxide at a low cost for a long time. That is, even in the case where a gas contains water, the filter 30 can suppress a decrease in absorption efficiency of carbon dioxide contained in the gas and further increase the absorption efficiency.

### SUMMARY

A carbon dioxide absorbent material (10, 10a) according to an aspect 1 of the present invention is a carbon dioxide absorbent material that absorbs carbon dioxide contained in a gas, the carbon dioxide absorbent material containing a tetravalent lithium silicate that exhibits water solubility.

According to the above configuration, since the carbon dioxide absorbent material of the aspect 1 contains a tetravalent lithium silicate that exhibits water solubility, the carbon dioxide absorbent material can absorb carbon dioxide from a gas containing water and carbon dioxide for a longer time than existing carbon dioxide absorbent materials. That is, even in the case where a gas contains water, the carbon dioxide absorbent material of the aspect 1 can suppress a decrease in absorption efficiency of carbon dioxide contained in the gas.

Use of the carbon dioxide absorbent material of the aspect 1 enables carbon dioxide to be absorbed in an environment in which a gas contains water, regardless of the amount of water contained per unit volume of the gas. Accordingly, since it is not necessary to arrange a dehumidification mechanism, the cost for arranging the dehumidification mechanism and the cost for operating the dehumidification mechanism can be reduced. Furthermore, the installation site of the dehumidification mechanism is unnecessary. This carbon dioxide absorbent material, which can absorb carbon dioxide without using a dehumidification mechanism even in an environment in which a gas contains water, has not been realized by the existing carbon dioxide absorbent materials described above. The carbon dioxide absorbent material of the aspect 1 can absorb carbon dioxide for a long time, in particular, in an environment in which the gas has a high water content (that is, a high humidity).

Furthermore, in the case where the carbon dioxide absorbent material of the aspect 1 is used, it is not necessary to arrange an absorption regeneration mechanism, which is necessary, in particular, when carbon dioxide is separated for a long time. Therefore, the cost for arranging the absorption regeneration mechanism and the cost for operating the absorption regeneration mechanism can be reduced. Furthermore, the installation site of the absorption regeneration mechanism is unnecessary.

As described above, the carbon dioxide absorbent material of the aspect 1 is advantageous in that carbon dioxide can be absorbed from a gas containing water and carbon dioxide at a low cost for a long time.

Furthermore, in the aspect 1, a carbon dioxide absorbent material (10a) according to an aspect 2 of the present invention preferably further contains potassium carbonate, in which a molar ratio of the potassium carbonate to the lithium silicate is preferably 0.01 or more and 0.1 or less.

The carbon dioxide absorbent material of the aspect 2 contains potassium carbonate. The molar ratio of the potassium carbonate to the lithium silicate is 0.01 or more and 0.1 or less. In this case, the absorption rate of carbon dioxide in the gas can be increased in the carbon dioxide absorbent material.

Therefore, the carbon dioxide absorbent material of the aspect 2 achieves, in addition to the advantage that carbon dioxide in the gas can be absorbed for a long time, an advantage that the carbon dioxide can be efficiently absorbed. That is, the carbon dioxide absorbent material of the aspect 2 is advantageous in that even in the case where a gas contains water, a decrease in absorption efficiency of carbon dioxide contained in the gas can be suppressed, and the absorption efficiency can be enhanced. Furthermore, according to the carbon dioxide absorbent material of the aspect 2, the above advantages can be achieved at a low cost.

Furthermore, according to a carbon dioxide absorbent material according to an aspect 3 of the present invention, in the aspect 1 or 2, in a case where an aqueous solution containing the lithium silicate in an amount of 0.17% by weight is prepared, the aqueous solution preferably has a transmittance of 88% or more for light applied to the aqueous solution, the light having a wavelength in a range of 240 nm or more and 400 nm or less.

According to the above configuration, the aqueous solution has a high transmittance of 88% or more for light having the above wavelength. Accordingly, the tetravalent lithium silicate contained in the carbon dioxide absorbent material of the aspect 1 or 2 can be determined to exhibit water solubility.

Furthermore, according to a carbon dioxide absorbent material according to an aspect 4 of the present invention, in the aspect 1 or 2, after an aqueous solution prepared by dissolving the lithium silicate in distilled water in a ratio of 1 g of the lithium silicate relative to 20 g of the distilled water is filtered, and 100 g of a resulting filtrate is maintained at 110° C. for 2 hours, an evaporation residue having a weight of 3.6 g or more is preferably yielded.

According to the above configuration, since the evaporation residue per 100 g of the filtrate in the state described above has a weight of 3.6 g or more, the tetravalent lithium silicate is considered to be contained in a state of being dissolved in the aqueous solution before the filtration. Therefore, when the weight is 3.6 g or more, the tetravalent lithium silicate contained in the carbon dioxide absorbent material of the aspect 1 or 2 can be determined to exhibit water solubility.

Furthermore, according to a carbon dioxide absorbent material according to an aspect 5 of the present invention, in the aspect 1 or 2, after an aqueous solution prepared by dissolving the lithium silicate in distilled water in a ratio of 1 g of the lithium silicate relative to 20 g of the distilled water is filtered, and 100 g of a resulting filtrate is maintained at 110° C. for 2 hours and further maintained at 700° C. for 10 hours, an evaporation residue having a weight of 2.9 g or more is preferably yielded.

According to the above configuration, since the evaporation residue per 100 g of the filtrate in the state described above has a weight of 2.9 g or more, the tetravalent lithium silicate is considered to be contained in a state of being dissolved in the aqueous solution before the filtration. Therefore, when the weight is 3.6 g or more, the tetravalent lithium silicate contained in the carbon dioxide absorbent material of the aspect 1 or 2 can be determined to exhibit water solubility.

Furthermore, a pellet (20) according to an aspect 6 of the present invention is a pellet that absorbs carbon dioxide contained in a gas and may contain the carbon dioxide absorbent material according to any one of the aspects 1 to 5.

According to the above configuration, the carbon dioxide absorbent material according to any one of the aspects 1 to 5 can be realized as a pellet. Therefore, multiplicity of use of the carbon dioxide absorbent material according to any one of the aspects 1 to 5 can be improved.

Furthermore, a filter (30) according to an aspect 7 of the present invention is a filter that absorbs carbon dioxide contained in a gas and may contain the pellet according to the aspect 6 therein.

According to the above configuration, the filter of the aspect 7 contains the pellet of the aspect 6 therein. Since the pellets are produced by pelletization so as to be larger than the powdery carbon dioxide absorbent material, the pellets can be contained in the filter in a state where the gaps between the pellets are larger than those in the case of a powder.

Therefore, the generation of the pressure loss described above can be suppressed, and carbon dioxide can be absorbed by the whole of the carbon dioxide absorbent material contained in the filter. Therefore, the filter of the aspect 7 can absorb carbon dioxide for a long time. That is, as in the carbon dioxide absorbent material according to any one of the aspects 1 to 5, even in the case where a gas contains water, the filter of the aspect 7 can also suppress a decrease in absorption efficiency of carbon dioxide contained in the gas.

The present invention is not limited to the embodiments described above, and various modifications can be made within the scope of claims. The technical scope of the present invention includes an embodiment that is obtained by a proper combination of technical means disclosed in the embodiments. Furthermore, the combination of the technical means disclosed in the embodiments enables the formation of a new technical feature.

### INDUSTRIAL APPLICABILITY

The present invention can be widely used in a carbon dioxide absorbent material that absorbs carbon dioxide contained in a gas.

### REFERENCE SIGNS LIST

10, 10a carbon dioxide absorbent material
20 pellet
30 filter

1. A carbon dioxide absorbent material that absorbs carbon dioxide contained in a gas,
the carbon dioxide absorbent material comprising a tetravalent lithium silicate that exhibits water solubility.

2. The carbon dioxide absorbent material according to claim 1, further comprising potassium carbonate,
wherein a molar ratio of the potassium carbonate to the lithium silicate is 0.01 or more and 0.1 or less.

3. The carbon dioxide absorbent material according to claim 1, wherein in a case where an aqueous solution containing the lithium silicate in an amount of 0.17% by weight is prepared, the aqueous solution has a transmittance of 88% or more for light applied to the aqueous solution, the light having a wavelength in a range of 240 nm or more and 400 nm or less.

4. The carbon dioxide absorbent material according to claim 1, wherein after an aqueous solution prepared by dissolving the lithium silicate in distilled water in a ratio of 1 g of the lithium silicate relative to 20 g of the distilled water is filtered, and 100 g of a resulting filtrate is maintained at 110° C. for 2 hours, an evaporation residue having a weight of 3.6 g or more is yielded.

5. The carbon dioxide absorbent material according to claim 1, wherein after an aqueous solution prepared by dissolving the lithium silicate in distilled water in a ratio of 1 g of the lithium silicate relative to 20 g of the distilled water is filtered, and 100 g of a resulting filtrate is maintained at 110° C. for 2 hours and further maintained at 700° C. for 10 hours, an evaporation residue having a weight of 2.9 g or more is yielded.

6. A pellet that absorbs carbon dioxide contained in a gas,
the pellet comprising the carbon dioxide absorbent material according to claim 1.

7. A filter that absorbs carbon dioxide contained in a gas,
the filter comprising the pellet according to claim 6 therein.

8. The carbon dioxide absorbent material according to claim 2, wherein in a case where an aqueous solution containing the lithium silicate in an amount of 0.17% by weight is prepared, the aqueous solution has a transmittance of 88% or more for light applied to the aqueous solution, the light having a wavelength in a range of 240 nm or more and 400 nm or less.

9. The carbon dioxide absorbent material according to claim 2, wherein after an aqueous solution prepared by dissolving the lithium silicate in distilled water in a ratio of 1 g of the lithium silicate relative to 20 g of the distilled water is filtered, and 100 g of a resulting filtrate is maintained at 110° C. for 2 hours, an evaporation residue having a weight of 3.6 g or more is yielded.

10. The carbon dioxide absorbent material according to claim 2, wherein after an aqueous solution prepared by dissolving the lithium silicate in distilled water in a ratio of 1 g of the lithium silicate relative to 20 g of the distilled water is filtered, and 100 g of a resulting filtrate is maintained at 110° C. for 2 hours and further maintained at 700° C. for 10 hours, an evaporation residue having a weight of 2.9 g or more is yielded.

11. A pellet that absorbs carbon dioxide contained in a gas,
the pellet comprising the carbon dioxide absorbent material according to claim 2.

12. A filter that absorbs carbon dioxide contained in a gas,
the filter comprising the pellet according to claim 11 therein.
